(19) United States
(12) Patent Application Publication
(10) Pub. No.: US 2020/0370915 A1
(43) Pub. Date: Nov. 26, 2020

(54) TRAVEL ASSIST SYSTEM, TRAVEL ASSIST METHOD, AND COMPUTER READABLE MEDIUM

(71) Applicant: Mitsubishi Electric Corporation, Tokyo (JP)

(72) Inventor: Michinori YOSHIDA, Tokyo (JP)

(73) Assignee: Mitsubishi Electric Corporation, Tokyo (JP)

(21) Appl. No.: 16/966,316

(22) PCT Filed: Mar. 23, 2018
(86) PCT No.: PCT/JP2018/011911

§ 371 Date: Jul. 30, 2020

(51) Int. Cl. G01C 21/36

(52) U.S. Cl. CPC G01C 21/3676; G01C 21/3694; G01C 21/367

(57) ABSTRACT

In a travel assist system (500), a positional information acquisition unit (110) acquires positional information (111) of a vehicle (200). A route generation unit (120) generates a travel route on a simple map (181), based on positional information (111) and the simple map (181) which is used for course guidance. A surrounding area map generation unit (130) generates a surrounding area map (182) of the vehicle during travel of the vehicle (200), using the positional information (111). A characteristic extraction unit (140) extracts a road characteristic on each of the simple map (181) and the surrounding area map (182). An alignment unit (150) aligns the simple map (181) and the surrounding area map (182) with each other based on the road characteristic, and calculates a vehicle position (151). Then, a path generation unit (170) projects a travel route onto the surrounding area map (182) using the vehicle position (151), and generates a path (171) for the vehicle (200) to take for traveling.

### TECHNICAL FIELD

The present invention relates to a travel assist system, a travel assist method, and a travel assist program. Particularly, the present invention relates to a travel assist system, a travel assist method, and a travel assist program which can generate a path to be employed in driving assist even on a road for which a high-precision map is not created.

### BACKGROUND ART

There is a technology for automated driving based on a high-precision map created in advance. Generally, a high-precision map such as a dynamic map is created for limited main roads such as an express way and an arterial road. However, a high-precision map is often not created for a local road which is not a main road.

Therefore, automated driving is impossible on a road for which a high-precision map is not created. Meanwhile, a simple map such as one installed in a car navigation system is created to include a local road as well. However, such a simple map lacks precision and information, and although a travel route can be generated from the simple map, a path for automated driving cannot be generated from the simple map.

Patent Literature 1 discloses a technique of estimating an own position by comparing, by a greedy method, an environment map created based on data from an in-vehicle sensor with a map created in advance.

### CITATION LIST

### Patent Literature

Patent Literature 1: JP 2014-002638 A

### SUMMARY OF INVENTION

### Technical Problem

In Patent Literature 1, it is not clear whether a map created in advance includes a local road which is not a main road. Therefore, there is a problem that for a road for which a high-precision map is not created, a path to be employed in driving assist such as automated driving cannot be generated.

An objective of the present invention is to generate, even for a local road for which a high-precision map has not been created, a path to be employed in driving assist such as automatic driving by utilizing a simple map employed in course guidance.

### Solution to Problem

A travel assist system according to the present invention, which assists travel of a vehicle, includes:

a positional information acquisition unit to acquire positional information of the vehicle;

a route generation unit to generate a travel route of the vehicle on a simple map used for course guidance, based on the positional information and simple map information which represents the simple map;

a surrounding area map generation unit to generate a surrounding area map of the vehicle, during travel of the vehicle, as surrounding area map information, using the positional information;

a characteristic extraction unit to extract a road characteristic on each of the surrounding area map and the simple map which includes the travel route;

an alignment unit to align the simple map and the surrounding area map with each other based on the road characteristic, and to calculate a position of the vehicle as a vehicle position; and

a path generation unit to project the travel route onto the surrounding area map using the vehicle position, and to generate a path for the vehicle to take for traveling the travel route, based on the travel route projected onto the surrounding area map.

### Advantageous Effects of Invention

In a travel assist system according to the present invention, an alignment unit aligns a simple map and a surrounding area map with each other based on a road characteristic, and calculates a position of a vehicle as a vehicle position. A path generation unit projects a travel route onto the surrounding area map using the vehicle position, and based on the travel route projected onto the surrounding area map, generates a path for the vehicle to take for traveling the travel route. Therefore, with the travel assist system according to the present invention, even for a local road for which a high-precision map has not been created, a path to be employed in driving assist such as automatic driving can be generated with using the simple map and the surrounding area map.

### BRIEF DESCRIPTION OF DRAWINGS

FIG. 1 is a configuration diagram of a travel assist system according to Embodiment 1.

FIG. 2 is a flowchart of a travelling assist process by a travel assist device according to Embodiment 1.

FIG. 3 is a diagram illustrating an example of a travel route on a simple map according to Embodiment 1.

FIG. 4 is a diagram illustrating an example of a surrounding area map according to Embodiment 1.

FIG. 5 is a diagram illustrating an example of a characteristic database according to Embodiment 1.

FIG. 6 is a detailed flowchart of a characteristic extraction process, an alignment process, and a correction amount calculation process according to Embodiment 1.

FIG. 7 is a configuration diagram of a travel assist system according to a modification of Embodiment 1.

FIG. 8 is a detailed flowchart of a characteristic extraction process, an alignment process, and a correction amount calculation process according to Embodiment 2.

FIG. 9 is a configuration diagram of a travel assist system according to Embodiment 3.

FIG. 10 is a detailed flowchart of a characteristic extraction process, an alignment process, and a correction amount calculation process according to Embodiment 3.

### DESCRIPTION OF EMBODIMENTS

Embodiments of the present invention will be described below with referring to drawings. In the drawings, the same or equivalent portion is denoted by the same reference sign. In description of embodiments, an explanation on the same or equivalent portion will be appropriately omitted or simplified.

### Embodiment 1

***Description of Configuration***

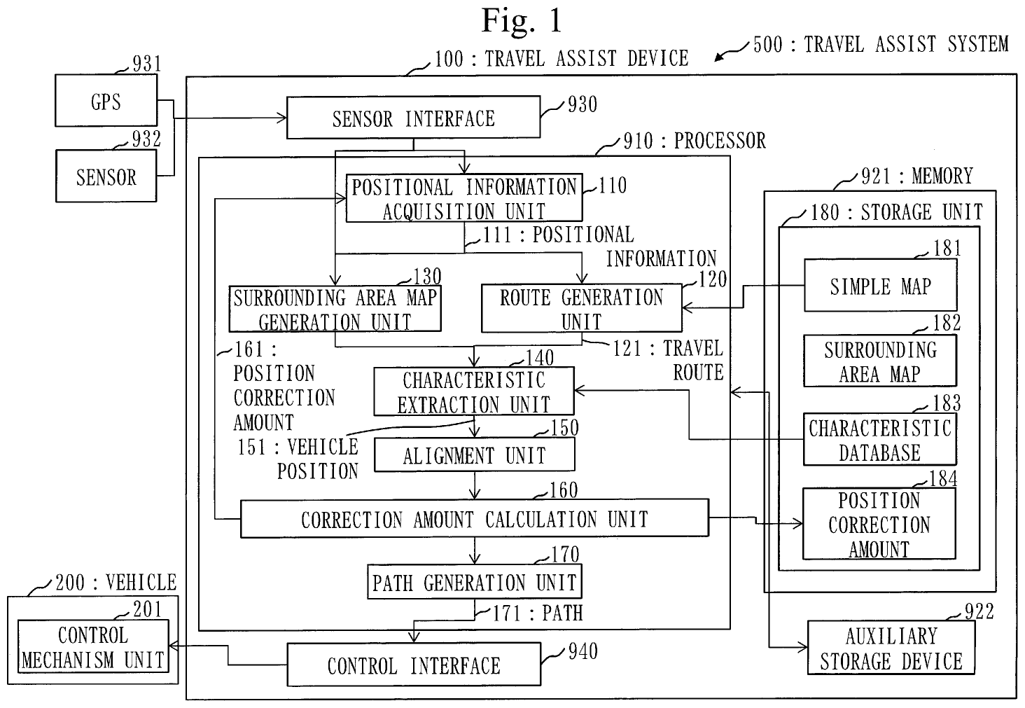

A configuration example of a travel assist system 500 according to the present embodiment will be described with referring to FIG. 1.

The travel assist system 500 assists travel of a vehicle 200. The vehicle 200 is an automated-driving car which travels by automated driving. In other words, the travel assist system 500 assists automated-driving travel of the vehicle 200.

The travel assist system 500 is provided with a travel assist device 100. In the present embodiment, the travel assist device 100 is mounted in the vehicle 200.

The travel assist device 100 is a computer. The travel assist device 100 is provided with a processor 910 and also with other hardware devices such as a memory 921, an auxiliary storage device 922, a sensor interface 930, and a control interface 940. The processor 910 is connected to the other hardware devices via signal lines and controls these other hardware devices.

The travel assist device 100 is provided with a positional information acquisition unit 110, a route generation unit 120, a surrounding area map generation unit 130, a characteristic extraction unit 140, an alignment unit 150, a correction amount calculation unit 160, a path generation unit 170, and a storage unit 180, as function elements. A simple map 181, a surrounding area map 182, a characteristic database 183, and a position correction amount 184 are stored in the storage unit 180.

Functions of the positional information acquisition unit 110, route generation unit 120, surrounding area map generation unit 130, characteristic extraction unit 140, alignment unit 150, correction amount calculation unit 160, and path generation unit 170 are implemented by software.

The storage unit 180 is provided to the memory 921. The storage unit 180 may be divided between the memory 921 and the auxiliary storage device 922.

The processor 910 is a device that executes a travel assist program. The travel assist program is a program that implements the functions of the positional information acquisition unit 110, route generation unit 120, surrounding area map generation unit 130, characteristic extraction unit 140, alignment unit 150, correction amount calculation unit 160, and path generation unit 170.

The processor 910 is an Integrated Circuit (IC) which performs arithmetic processing. A specific example of the processor 910 is a Central Processing Unit (CPU), a Digital Signal Processor (DSP), or a Graphics Processing Unit (GPU).

The memory 921 is a storage device which stores data temporarily. A specific example of the memory 921 is a Static Random-Access Memory (SRAM) or a Dynamic Random-Access Memory (DRAM).

The auxiliary storage device 922 is a storage device which stores data. A specific example of the auxiliary storage device 922 is an HDD. Alternatively, the auxiliary storage device 922 may be a portable storage medium such as an SD (registered trademark) card, a CF, a NAND flash, a flexible disk, an optical disk, a compact disk, a blu-ray (registered trademark) disk, and a DVD. Note that HDD stands for Hard Disk Drive, SD (registered trademark) stands for Secure Digital, CF stands for CompactFlash (registered trademark), and DVD stands for Digital Versatile Disk.

The sensor interface 930 is connected to a Global Positioning System (GPS) 931 and various types of sensors 932. Practical examples of the sensors 932 are a camera, a laser, an millimeter-wave radar, and a sonar. The GPS 931 and the sensors 932 are mounted in the vehicle 200. The sensor interface 930 transmits information acquired by the GPS 931 and the sensors 932 to the processor 910.

The control interface 940 is connected to a control mechanism unit 201 of the vehicle 200. An automated-driving path 171 generated by the processor 910 is transmitted to the control mechanism unit 201 of the vehicle 200 via the control interface 940. The control interface 940 is specifically a port to be connected to a Controller Area Network (CAN).

The travel assist program is read by the processor 910 and executed by the processor 910. Not only the travel assist program but also an Operating System (OS) is stored in the memory 921. The processor 910 executes the travel assist program while executing the OS. The travel assist program and the OS may be stored in the auxiliary storage device 922. The travel assist program and the OS stored in the auxiliary storage device 922 are loaded in the memory 921 and executed by the processor 910. The travel assist program may be incorporated in the OS partly or entirely.

The travel assist system 500 may be provided with a plurality of processors that substitute for the processor 910. The plurality of processors share execution of the travel assist program. Each processor is a device that executes the travel assist program, as the processor 910 does.

Data, information, signal values, and variable values utilized, processed, or outputted by the travel assist program are stored in the memory 921, the auxiliary storage device 922, or a register or cache memory in the processor 910.

“Unit” in each of the positional information acquisition unit, the route generation unit, the surrounding area map generation unit, the characteristic extraction unit, the alignment unit, the correction amount calculation unit, and the path generation unit may be replaced by “process”, “procedure”, or “stage”. Also, “process” in each of a positional information acquisition process, a route generation process, a surrounding area map generation process, a characteristic extraction process, an alignment process, a correction amount calculation process, and a path generation process may be replaced by “program”, “program product”, or “computer readable storage medium recorded with a program”.

The travel assist program causes the computer to execute processes, procedures, or stages corresponding to the individual “units” mentioned above, with their “unit” being replaced by “process”, “procedure”, or “stage”. A travel assist method is a method carried out by the travel assist system 500 through execution of the travel assist program.

The travel assist program may be stored in a computer readable recording medium and provided in the form of the recording medium. Alternatively, the travel assist program may be provided in the form of a program product.

***Description of Operations***

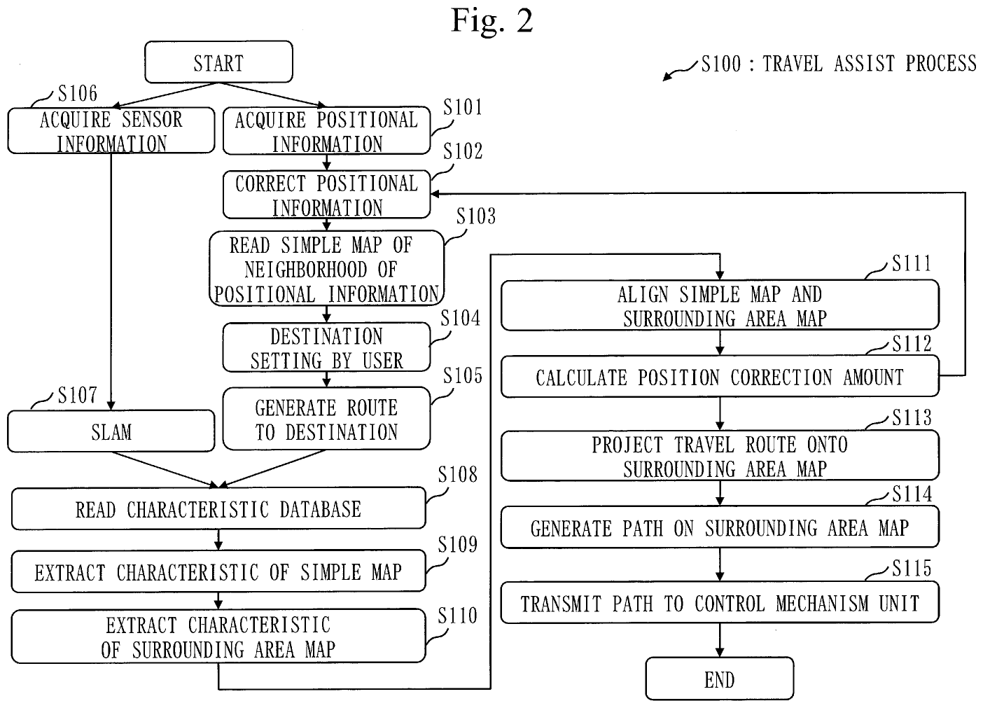

Travel assist process S100 of the travel assist device 100 according to the present embodiment will be described with referring to FIG. 2.

In the travel assist device 100 according to the present embodiment, the automated-driving path is generated with utilizing the simple map 181 that is existing, instead of a high-precision map created in advance. The simple map 181 has a precision sufficient to enable route display, as a map mounted in a car navigation system does. The travel assist device 100 generates a path for an automated-driving car using the simple map 181 and sensor information from the sensors 932 which acquire surrounding area information. A map created from the sensor information is called surrounding area map 182. In travel assist process S100 according to the present embodiment, a travel route formed on the simple map 181 is mapped onto the surrounding area map 182 by aligning the simple map 181 and the surrounding area map 182 with each other. An automated-driving path is generated with using the surrounding area map 182 on which the travel route is superposed.

A travel route and a path will be defined. A travel route is a route on a map used for course guidance by a car navigation system or the like and indicates which road to take. A path indicates a vehicle travel track and a vehicle course which are to be inputted to a vehicle control mechanism of an automated-driving car.

<Positional Information Acquisition Process>

In step S101, the positional information acquisition unit 110 acquires positional information 111 of the vehicle 200. Specifically, the positional information acquisition unit 110 acquires, via the sensor interface 930, the positional information 111 acquired by the GPS 931. The positional information 111 is also referred to as GPS information.

In step S102, the positional information acquisition unit 110 corrects the positional information 111 based on the position correction amount 184.

<Route Generation Process>

Subsequently, the route generation unit 120 generates a travel route 121 of the vehicle 200 on the simple map 181 used for course guidance, based on the positional information 111 and simple map information which represents the simple map 181. The simple map 181 is specifically a map used by the car navigation system. Generally, the simple map 181 has been created to include also a local road which is not a main road such as an express way and an arterial road.

In step S103, the route generation unit 120 reads the simple map 181 stored in the storage unit 180. Specifically, the route generation unit 120 reads the simple map 181 of a neighborhood of a position indicated by the positional information 111.

In step S104, the route generation unit 120 accepts destination setting of a user. Specifically, the route generation unit 120 accepts destination setting using the car navigation system.

In step S105, the route generation unit 120 generates on the simple map 181 the travel route 121 to the destination from the present position indicated by the positional information 111.

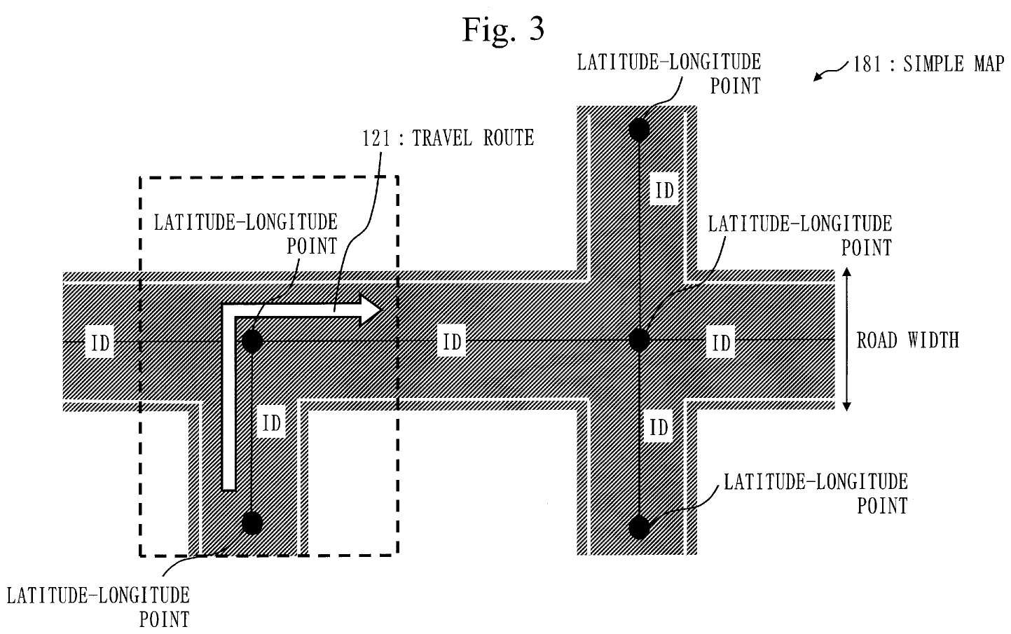

FIG. 3 illustrates an example of the travel route 121 on the simple map 181 according to the present embodiment.

As illustrated in FIG. 3, the route generation unit 120 generates the travel route 121 on the simple map 181 of the car navigation system.

<Surrounding Area Map Generation Process>

Subsequently, the surrounding area map generation unit 130 generates, during travel of the vehicle 200, the surrounding area map 182 of the vehicle 200 as surrounding area map information, using the positional information 111. The surrounding area map generation unit 130 specifically generates the surrounding area map 182 by Simultaneous Localization And Mapping (SLAM).

In step S106, the surrounding area map generation unit 130 acquires, via the sensor interface 930, the sensor information acquired by the various types of sensors 932.

In step S107, the surrounding area map generation unit 130 estimates an own position and generates the surrounding area map 182 simultaneously by the SLAM technique, using the sensor information such as a camera image and a point cloud from the laser sensor.

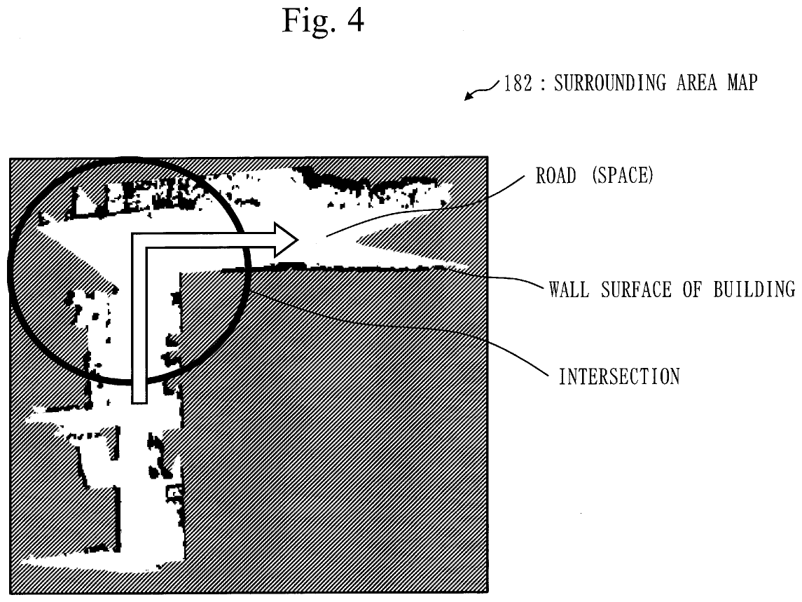

FIG. 4 illustrates an example of the surrounding area map 182 according to the present embodiment.

As illustrated in FIG. 4, with SLAM in the vehicle 200, a shape of a surrounding atmosphere is perceived by the sensors 932, and the own position is estimated from shape data. Also, with SLAM in the vehicle 200, the own position is estimated, the surrounding area map 182 is generated while correction of the own position is performed, and the vehicle 200 is moved. The surrounding area map 182 employs xyz coordinate representation, and latitude-longitude information is stored in a portion of the surrounding area map 182. The surrounding area map 182 is a map generated from the sensor information online in a real-time manner.

<Characteristic Extraction Process>

Subsequently, the characteristic extraction unit 140 extracts a road characteristic on each of the surrounding area map 182 and the simple map 181 which includes the travel route 121. Based on the road characteristic specified by the characteristic database 183, the characteristic extraction unit 140 extracts the road characteristic from each of the surrounding area map 182 and the simple map 181 which includes the travel route 121.

First, in step S108, the characteristic extraction unit 140 reads the characteristic database 183 which specifies the road characteristic.

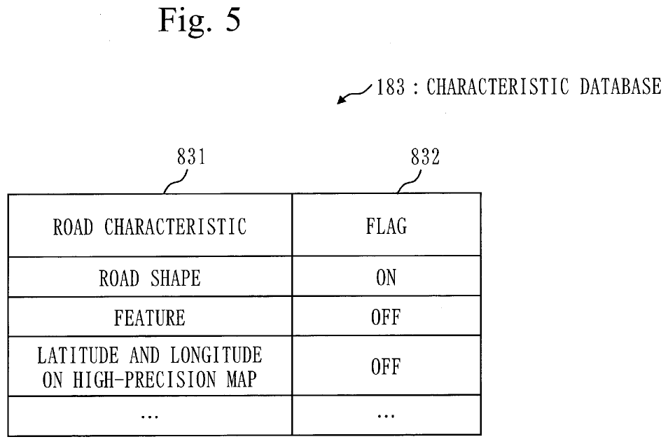

An example of the characteristic database 183 according to the present embodiment will be described with referring to FIG. 5.

A road characteristic 831 used for alignment and a flag 832 corresponding to the road characteristic 831 are set in the characteristic database 183. A practical example of the road characteristic 831 is a characteristic such as a road shape and a feature. In the characteristic database 183, the road characteristic 831 used for alignment is specified by ON and OFF of the flag 832. As a detailed item of the road characteristic 831, an item such as a number of roads at an intersection, an angle between roads at the intersection, and a structure, sign, or wall at the intersection may be set.

In the present embodiment, the road characteristic 831 is specified with using the flag 832. The characteristic database 183 may have another configuration as far as it can specify the road characteristic 831.

In step S109, the characteristic extraction unit 140 extracts the road characteristic on the simple map 181 of the vicinity of the position indicated by the positional information 111.

In step S110, the characteristic extraction unit 140 extracts the road characteristic on the surrounding area map 182.

In step S109 and step S110, the road characteristic to be extracted has been specified by the characteristic database 183.

<Alignment Process>

In step S111, the alignment unit 150 aligns the simple map 181 and the surrounding area map 182 with each other based on the road characteristic, and calculates a position of the vehicle as a vehicle position 151. Specifically, the alignment unit 150 first performs rough alignment referring to the latitude and longitude. Then, the alignment unit 150 performs detailed alignment based on the road characteristic, so that a coincident point between the simple map 181 and the surrounding area map 182 can be found. Note that the vehicle position 151 is also referred to as the own position of the vehicle 200. The precision of the vehicle position 151 calculated here is higher than the precision of the positional information 111 obtained by the GPS 931 and is sufficient to enable generation of a path for automated driving.

<Correction Amount Calculation Process>

In step S112, the correction amount calculation unit 160 calculates a position correction amount 161 for correcting the positional information 111, based on the vehicle position 151 calculated by the alignment unit 150. The position correction amount 161 is used for correction of the positional information 111 by the GPS 931.

<<Characteristic Extraction Process, Alignment Process, and Correction Amount Calculation Process>>

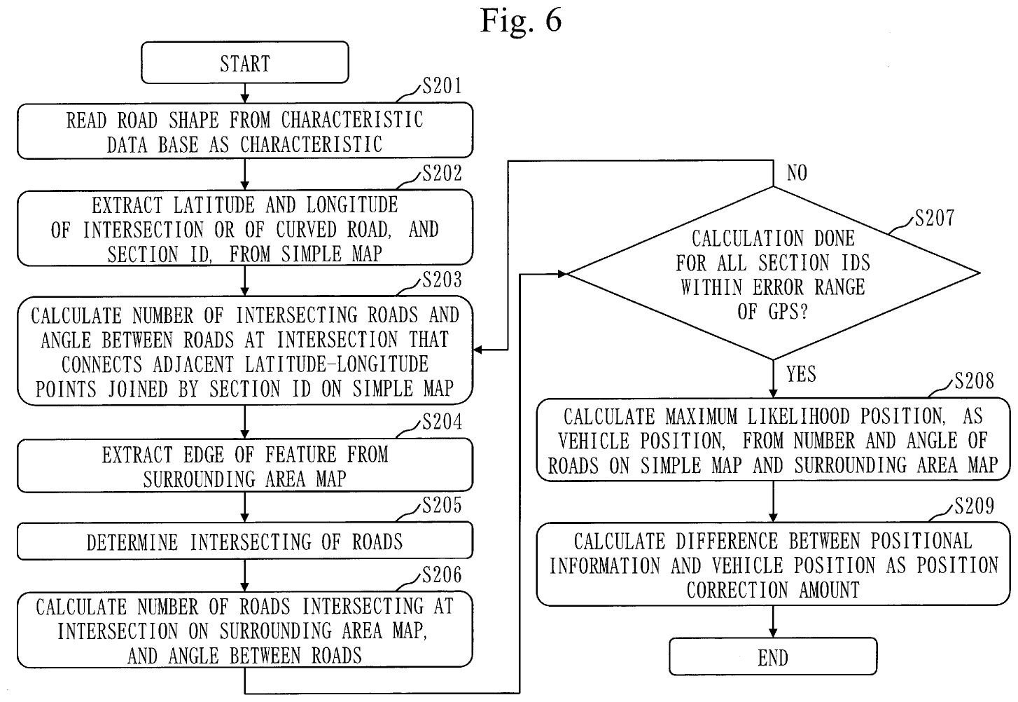

A characteristic extraction process, an alignment process, and a correction amount calculation process according to the present embodiment will be described in detail with referring to FIG. 6.

In the present embodiment, assume that a road shape is specified as the road characteristic by the characteristic database 183. The number of roads and the angle between the roads are derived from the road shape on the surrounding area map 182. The number of roads and the angle between the roads are derived from the simple map 181. By obtaining the number of intersecting roads and the angle between the roads in this manner, a coincident point between the surrounding area map 182 and the simple map 181 can be found.

A road included in each of the surrounding area map 182 and the simple map 181 which includes the travel route 121 is composed of a plurality of section Identifiers (IDs). The characteristic extraction unit 140 extracts the road characteristic using each of the plurality of section IDs. As illustrated in FIG. 3, a plurality of latitude-longitude points are set on the roads. The latitude-longitude points are each a point at which a latitude and longitude of a portion are extracted, such as points extracted at an arbitrary spacing, a central portion of an intersection, and a curved portion of a curved road. The section ID distinguishes a road section that connects adjacent latitude-longitude points among these latitude-longitude points.

In step S201, the characteristic extraction unit 140 determines a road characteristic 831 whose flag 832 is ON in the characteristic database 183. In the present embodiment, the characteristic extraction unit 140 reads the road shape as the road characteristic. Step S201 corresponds to step S108 of FIG. 2.

In step S202, the characteristic extraction unit 140 extracts a road shape, including a number of intersecting roads and an angle between the intersecting roads, as the road characteristic of the simple map 181. Specifically, the characteristic extraction unit 140 extracts a latitude-longitude point of a central portion of an intersection, or a latitude-longitude point of a portion of a curved road which can be linearly approximated, on the simple map 181. Then, the characteristic extraction unit 140 extracts information of a section ID indicating a relationship among a plurality of latitude-longitude points, and information of a portion where lanes or a road width exists. In this manner, the characteristic extraction unit 140 extracts the latitude-longitude points of the intersections or of the curved road from the simple map 181, and extracts the section ID.

In step S203, the characteristic extraction unit 140 calculates the number of intersecting roads and the angle between the roads at an intersection that connects adjacent latitude-longitude points joined by the section ID on the simple map 181.

Step S202 and step S203 correspond to step S109 of FIG. 2.

In step S204, the characteristic extraction unit 140 extracts an edge of a feature from the surrounding area map 182. As illustrated in FIG. 4, the characteristic extraction unit 140 extracts a wall surface or border line of a building, as the edge.

In step S205, the characteristic extraction unit 140 determines roads from the edge of the feature, and determines intersecting of the roads.

In step S206, the characteristic extraction unit 140 calculates the number of roads intersecting at the intersection on the surrounding area map 182, and the angle between the roads. Specifically, the characteristic extraction unit 140 determines the roads by extracting a characteristic such as a wall surface of a building and an edge of a space portion. When intersecting of the roads is determined, the characteristic extraction unit 140 recognizes the intersecting as an intersection, and obtains the number of intersecting roads and the angle between the roads.

Step S204 to step S206 correspond to step S110 of FIG. 2.

In step S207, the characteristic extraction unit 140 determines whether calculation has been done for all section IDs within an error range of the GPS, from the present position expressed by the positional information 111. The error range of the GPS is specifically a range of about 10 m. If calculation has been done for all the section IDs within the error range of the GPS, the processing proceeds to step S208. If there is a section ID for which calculation has not been done, the procedure proceeds to step S203.

In step S208, the alignment unit 150 obtains a coincident point where the number of roads detected from the surrounding area map 182 and the angle between the roads respectively coincide with the number of roads detected from the simple map 181 and the angle between the roads. Based on the coincident point, the alignment unit 150 aligns the simple map 181 and the surrounding area map 182 with each other. Then, as a result of alignment of the simple map 181 and the surrounding area map 182, the alignment unit 150 calculates a maximum likelihood position, which is a position of the own vehicle, as the vehicle position 151.

Step S208 corresponds to step S111 of FIG. 2.

In step S209, the correction amount calculation unit 160 calculates a difference between the vehicle position 151 and the positional information 111 which is obtained by the GPS, as the position correction amount 161 to be used for correcting the positional information 111. Using the position correction amount 161, the correction amount calculation unit 160 updates the position correction amount 184 stored in the storage unit 180.

Step S209 corresponds to step S112 of FIG. 2.

The alignment unit 150 may perform the following processing.

Upon reaching an intersection next to an area surrounded by a circle in FIG. 4, that is, an intersection on the right in FIG. 4, the alignment unit 150 executes map alignment described above again. Then, the alignment unit 150 reviews whether alignment up to the last time is correct. If the simple map 181 and the surrounding area map 182 for the past intersection do not coincide, then for the present intersection, the simple map 181 and the surrounding area map 182 are matched to the present intersection. On the other hand, if the simple map 181 and the surrounding area map 182 coincide for the past intersection but do not coincide for the present intersection, matching for the present intersection is calculated again, or calculation is performed for an intersection next to the location where the simple map 181 and the surrounding area map 182 coincided.

<Path Generation Process>

Back to FIG. 2, the description will continue.

The path generation unit 170 projects the travel route onto the surrounding area map 182 using the vehicle position 151. Then, based on the travel route projected onto the surrounding area map 182, the path generation unit 170 generates the path 171 for the vehicle 200 to take for traveling the travel route. The path 171 is, for example, a path for the vehicle 200 to take for traveling the travel route by automated driving. In other words, based on a result of alignment, the path generation unit 170 maps the travel route generated with utilizing the simple map 181 onto the surrounding area map 182 generated from the sensor information. Then, the path generation unit 170 draws the path 171 in addition to the travel road on the surrounding area map 182, thereby enabling automated driving.

In step S113, the path generation unit 170 projects the travel route onto the surrounding area map 182.

In step S114, using the surrounding area map 182 on which the travel route has been projected, the path generation unit 170 generates the path 171 for automated driving.

In step S115, the path generation unit 170 transmits the path 171 to the control mechanism unit 201 via the control interface 940.

***Other Configurations***

<Modification 1>

In the present embodiment, the travel assist device 100 is mounted in the vehicle 200. However, some of the functions of the travel assist device 100 may be assigned to a center server. In this case, the travel assist device 100 is provided with a communication device to communicate with the center server. The communication device communicates with another device, specifically the center server, via a network. The communication device has a receiver and a transmitter. The communication device is connected to a communication network such as a LAN, the Internet, and a telephone line, by wireless connection. The communication device is specifically a communication chip or a Network Interface Card (NIC).

<Modification 2>

The travel assist device 100 may be provided with an input interface and an output interface. The input interface is a port to be connected to an input device such as a mouse, a keyboard, and a touch panel. The input interface is specifically a Universal Serial Bus (USB) terminal. Alternatively, the input interface may be a port to be connected to a LAN or a CAN which is an in-vehicle network.

The output interface is a port to be connected to a cable of an output apparatus such as a display. The output interface is specifically a USB terminal or a High Definition Multimedia Interface (HDMI; registered trademark) terminal. The display is specifically a Liquid Crystal Display (LCD).

<Modification 3>

In the present embodiment, the functions of the positional information acquisition unit 110, route generation unit 120, surrounding area map generation unit 130, characteristic extraction unit 140, alignment unit 150, correction amount calculation unit 160, and path generation unit 170 are implemented by software. In a modification, the functions of the positional information acquisition unit 110, route generation unit 120, surrounding area map generation unit 130, characteristic extraction unit 140, alignment unit 150, correction amount calculation unit 160, and path generation unit 170 may be implemented by hardware.

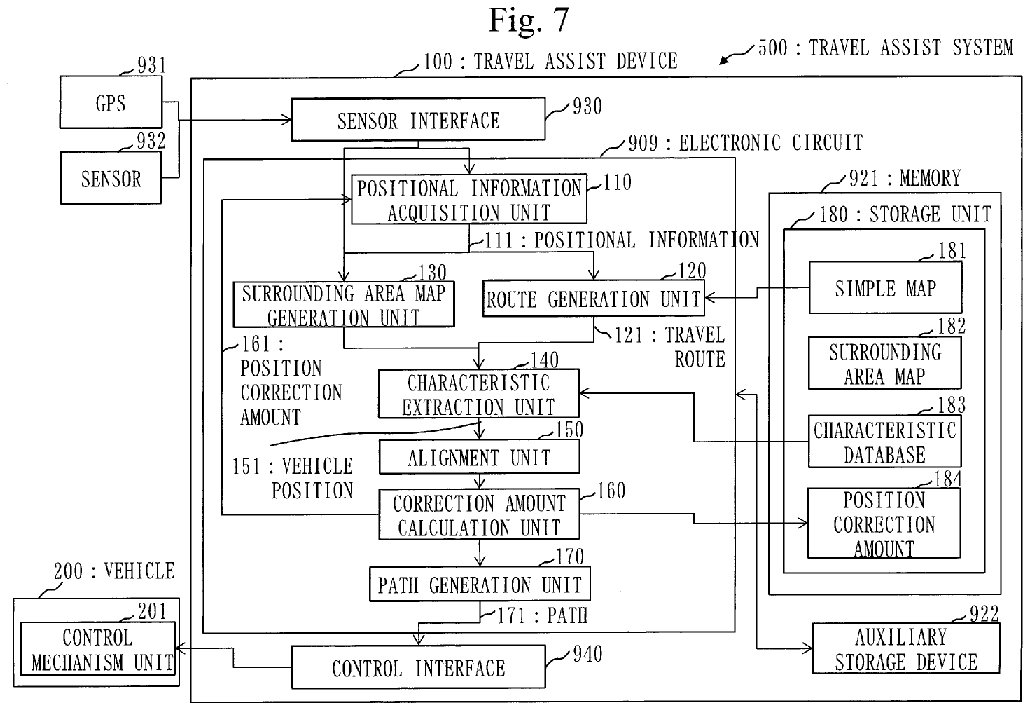

FIG. 7 is a diagram illustrating a configuration of a travel assist system 500 according to a modification of the present embodiment.

A travel assist device 100 is provided with an electronic circuit 909, a memory 921, an auxiliary storage device 922, a sensor interface 930, and a control interface 940.

The electronic circuit 909 is a dedicated electronic circuit that implements the functions of the positional information acquisition unit 110, route generation unit 120, surrounding area map generation unit 130, characteristic extraction unit 140, alignment unit 150, correction amount calculation unit 160, and path generation unit 170.

The electronic circuit 909 is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array.

The functions of the positional information acquisition unit 110, route generation unit 120, surrounding area map generation unit 130, characteristic extraction unit 140, alignment unit 150, correction amount calculation unit 160, and path generation unit 170 may be implemented by a single electronic circuit, or by a plurality of electronic circuits through distribution.

In another modification, some of the functions of the positional information acquisition unit 110, route generation unit 120, surrounding area map generation unit 130, characteristic extraction unit 140, alignment unit 150, correction amount calculation unit 160, and path generation unit 170 may be implemented by an electronic circuit, and the remaining functions may be implemented by hardware.

The processor and the electronic circuit are also called processing circuitry. That is, in the travel assist device 100, the functions of the positional information acquisition unit 110, route generation unit 120, surrounding area map generation unit 130, characteristic extraction unit 140, alignment unit 150, correction amount calculation unit 160, and path generation unit 170 are implemented by processing circuitry.

### DESCRIPTION OF EFFECT OF PRESENT EMBODIMENT

In the travel assist system according to the present embodiment, information concerning a constituent element of the map is extracted for each of the map information on the travel route on the simple map and the surrounding area map which is generated from the sensor information. A specific example of the constituent element of the map is an intersection or a curved road. A specific example of the information concerning the constituent element of the map is information such as the latitude and longitude or a section ID. Using the extracted information, the travel assist system aligns the simple map and the surrounding area map with each other, projects the travel route indicated on the simple map onto the surrounding area map, and generates the path based on the projected travel route and the information of the surrounding area map.

Hence, with the travel assist system according to the present embodiment, when a simple map is available, a path can be generated even if a high-precision map is not available.

In the travel assist system according to the present embodiment, positional information by the GPS can be corrected by information of the own vehicle. Conventionally, a GPS correction signal is received from the outside. With the travel assist system according to the present embodiment, position correction by the GPS is possible even within an area where a GPS correction signal cannot be received.

### Embodiment 2

In the present embodiment, a difference from Embodiment 1 will mainly be described.

In the present embodiment, the same configuration as that of Embodiment 1 will be denoted by the same reference sign, and its description will be omitted.

In the present embodiment, a characteristic extraction unit 140 extracts a position and shape of a feature, as a road characteristic. The characteristic extraction unit 140 extracts a position of a characteristic feature such as a structure and a sign from a surrounding area map 182 and a simple map 181, and performs alignment using a feature that is common between the surrounding area map 182 and the simple map 181.

A configuration of a travel assist system 500 and a configuration of a travel assist device 100 according to the present embodiment are the same as those in Embodiment 1.

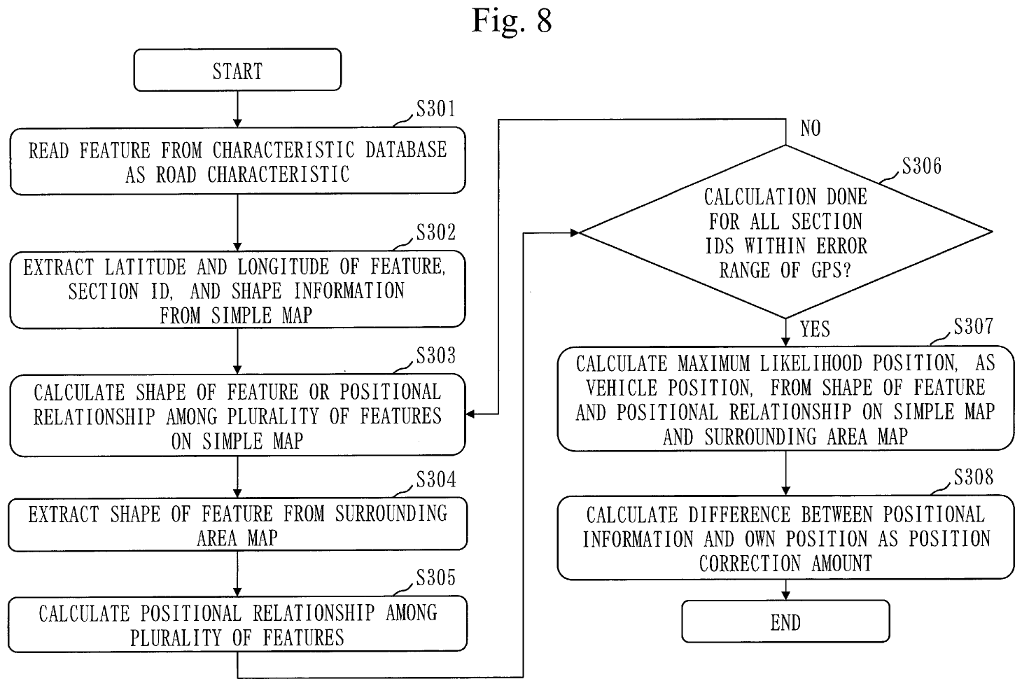

A characteristic extraction process, an alignment process, and a correction amount calculation process according to the present embodiment will be described in detail with referring to FIG. 8. FIG. 8 is a flowchart corresponding to FIG. 6 of Embodiment 1.

In the present embodiment, assume that a feature has been specified by a characteristic database 183 as a road characteristic. In the present embodiment, when a characteristic feature is held by the simple map 181, a coincident point between the simple map 181 and the surrounding area map 182 is found based on installation positions of the road and feature. A feature refers to a characteristic structure such as a structure and a sign near the road.

In step S301, the characteristic extraction unit 140 determines a road characteristic 831 whose flag 832 is ON in the characteristic database 183. In the present embodiment, the characteristic extraction unit 140 reads a position of the feature as the road characteristic.

In step S302, the characteristic extraction unit 140 extracts a position of the feature and a shape of the feature, as the road characteristic of the simple map 181. Specifically, the characteristic extraction unit 140 extracts the feature, a latitude and longitude of the feature, the section ID, and shape information from the simple map 181.

In step S303, the characteristic extraction unit 140 calculates the shape of the feature, or a positional relationship among a plurality of features.

In step S304, the characteristic extraction unit 140 extracts the shape of the feature from the surrounding area map 182.

In step S305, the characteristic extraction unit 140 calculates the positional relationship among the plurality of features on the surrounding area map 182.

In step S306, the characteristic extraction unit 140 determines whether calculation has been done for all section IDs within an error range of the GPS. If calculation has been done for all the section IDs within the error range of the GPS, the processing proceeds to step S307. If there is a section ID for which calculation has not been done, the procedure returns to step S303. Step S306 is the same as step S207 of FIG. 6.

In step S307, an alignment unit 150 obtains a coincident point where the shape of the feature and the positional relationship which are detected from the surrounding area map 182 respectively coincide with the shape of the feature and the positional relationship which are detected from the simple map 181. Based on the coincident point, the alignment unit 150 aligns the simple map 181 and the surrounding area map 182 with each other. Then, the alignment unit 150 calculates a maximum likelihood position, which is a position of the own vehicle, as a vehicle position 151.

In step S308, a correction amount calculation unit 160 calculates a difference between the vehicle position 151 and positional information 111 which is obtained by the GPS, as a position correction amount 161 to be used for correcting the positional information 111. Using the position correction amount 161, the correction amount calculation unit 160 updates a position correction amount 184 stored in a storage unit 180. Step S308 is the same as step S209 of FIG. 6.

In the travel assist system according to the present embodiment, when a characteristic structure such as a building or sign near the road is held by the simple map, a coincident point can be obtained based on installation positions of the road and structure. With the travel assist system according to the present embodiment, when a constituent element of the map is newly learned, the path can be calculated again.

### Embodiment 3

In the present embodiment, a difference from Embodiments 1 and 2 will mainly be described.

In the present embodiment, the same configuration as those in Embodiments 1 and 2 will be denoted by the same reference sign, and its description will be omitted.

In the present embodiment, when a high-precision map 185 such as a dynamic map is obtained, the high-precision map 185 and a simple map 181 are aligned with each other with using a latitude and longitude of the high-precision map 185 and of a simple map 181 via the surrounding area map 182.

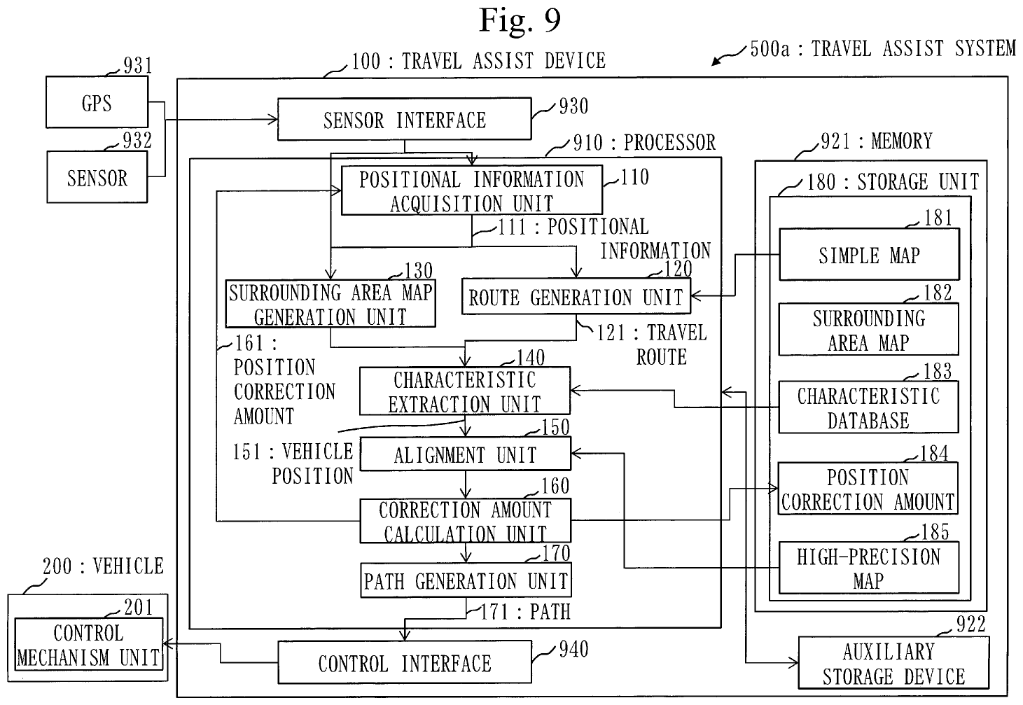

A configuration example of a travel assist system 500a according to the present embodiment will be described with referring to FIG. 9. The travel assist system 500a is different from Embodiment 1 in that the high-precision map 185 is stored in a storage unit 180. The high-precision map 185 is used for automated driving. The high-precision map 185 has a higher precision than the simple map 181. Specifically, the high-precision map 185 is a dynamic map.

An alignment unit 150 aligns the high-precision map 185 and the surrounding area map 182 with each other and aligns the simple map 181 and the surrounding area map 182 with each other, thereby aligning the high-precision map 185 and the simple map 181 with each other. By aligning the high-precision map 185 and the simple map 181 with each other, the alignment unit 150 calculates a high-precision vehicle position 151.

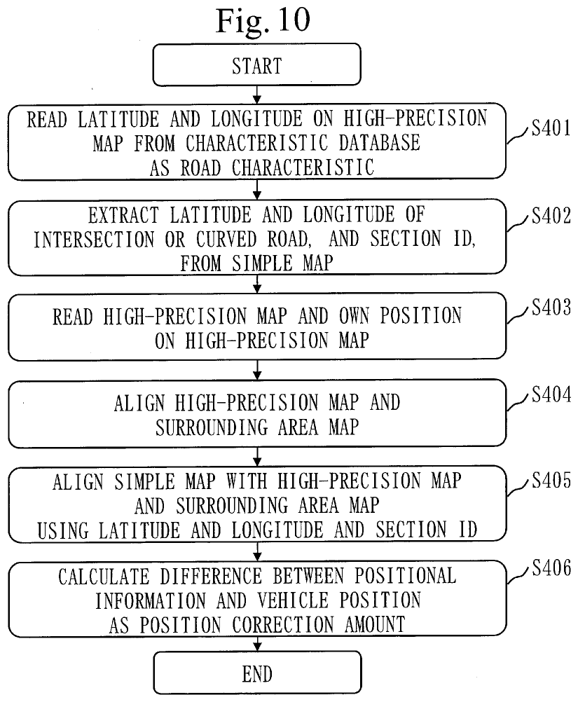

A characteristic extraction process, an alignment process, and a correction amount calculation process according to the present embodiment will be described in detail with referring to FIG. 10.

In the present embodiment, assume that a latitude and longitude of a high-precision map is specified by a characteristic database 183, as a road characteristic. In a specific example, when a vehicle 200 travels in the vicinity of a boundary between the high-precision map 185 and the simple map 181, the characteristic database 183 may specify the latitude and longitude on the high-precision map 185 automatically.

In step S401, a characteristic extraction unit 140 determines a road characteristic 831 whose flag 832 is ON in the characteristic database 183. In the present embodiment, the characteristic extraction unit 140 reads a latitude and longitude on the high-precision map 185 as the road characteristic.

In step S402, the characteristic extraction unit 140 extracts a latitude and longitude of an intersection or curved road and a section ID from the simple map 181.

In step S403, the characteristic extraction unit 140 reads the high-precision map 185 from the storage unit 180, and acquires an own position on the high-precision map 185. At this time, the characteristic extraction unit 140 acquires the own position on the high-precision map 185 using sensor information acquired by a sensors 932.

In step S404, the alignment unit 150 aligns the high-precision map 185 and the surrounding area map 182 with each other using the latitude and longitude on the high-precision map 185 and a latitude and longitude on the surrounding area map 182.

In step S405, the alignment unit 150 aligns the high-precision map 185 and the simple map 181 with each other by aligning the simple map 181 and the surrounding area map 182 with each other using the latitude and longitude and the section ID. The alignment unit 150 calculates the vehicle position 151 by aligning the high-precision map 185 and the simple map 181 with each other. When aligning the simple map 181 and the surrounding area map 182 with each other, Embodiment 1 or 2 may be employed.

In step S406, a correction amount calculation unit 160 calculates a difference between the vehicle position 151 and positional information 111 which is obtained by the GPS, as a position correction amount 161 to be used for correcting the positional information 111. Using the position correction amount 161, the correction amount calculation unit 160 updates a position correction amount 184 stored in the storage unit 180. Step S406 is the same as step S209 of FIG. 6.

In the travel assist system according to the present embodiment, alignment of the high-precision map 185 and the simple map 181 can be performed via the surrounding area map 182. The present embodiment can be applied if the travel assist system possess a high-precision map and if a vehicle is located near a boundary with an area for which the high-precision map exists. With the travel assist system according to the present embodiment, alignment of a high-precision map and a simple map becomes possible, so that a higher-precision vehicle position can be calculated.

In above Embodiments 1 to 3, the individual units in the travel assist device are described as independent function blocks. However, the travel assist device need not necessarily have a configuration as in the above embodiments. The function blocks of the travel assist device may form any configuration as far as they can implement the functions described in the above embodiments.

Of Embodiments 1 to 3 described above, a plurality of portions may be practiced in combination. Alternatively, of these embodiments, one portion may be practiced. Also, these embodiments may be practiced in any combination entirely or partly.

The embodiments described above are essentially preferable exemplifications and are not intended to limit the scope of the present invention, the scope of the applied product of the present invention, and the scope of the application of the present invention. Various changes can be made to the above embodiments as necessary.

The above description is directed to a case where the invention of the present application is applied to a travel assist device system which assists travel of an automated-driving car. However, the invention of the present invention can be applied not only to travel assist of an automated-driving vehicle but also to car navigation which performs guidance of a course to a destination.

For example, in a travel assist system such as a car navigation system, if a generated path, in addition to a travel route, is also provided to the car navigation, even a driver of a non-automated-driving car can perceive an on-road travel position such as a lane to follow, based on information from the car navigation. Furthermore, since the car travels while a map is being generated based on the sensor information, an obstacle position can also be perceived, so that a safe course can be presented.

### REFERENCE SIGNS LIST

100: travel assist device; 110: positional information acquisition unit; 111: positional information; 120: route generation unit; 121: travel route; 130: surrounding area map generation unit; 140: characteristic extraction unit; 150: alignment unit; 151: vehicle position; 160: correction amount calculation unit; 170: path generation unit; 171: path; 180: storage unit; 181: simple map; 182: surrounding area map; 183: characteristic database; 161, 184: position correction amount; 185: high-precision map; 200: vehicle; 201: control mechanism unit; 500, 500a: travel assist system; 831: road characteristic; 832: flag; 909: electronic circuit; 910: processor; 921: memory; 922: auxiliary storage device; 930: sensor interface; 931: GPS; 932: sensor; 940: control interface; S100: travel assist process.

1. A travel assist system which assists travel of a vehicle, comprising:
processing circuitry
to acquire positional information of the vehicle,
to generate a travel route indicating which road the vehicle takes on a simple map used for course guidance, utilizing the positional information and simple map information which represents the simple map,
to generate a surrounding area map of the vehicle, during travel of the vehicle, as surrounding area map information, using the positional information and sensor information which is acquired by a sensor mounted in the vehicle, the surrounding area map having a higher precision than the simple map,
to extract a road characteristic on each of the surrounding area map and the simple map which includes the travel route,
to align the simple map and the surrounding area map with each other based on the road characteristic, and to calculate a position of the vehicle as a vehicle position, and
to project the travel route generated with utilizing the simple map information and the positional information onto the surrounding area map using the vehicle position, and to generate a path for the vehicle to take for traveling the travel route, based on the travel route projected onto the surrounding area map, the path being a travel track of the vehicle and a course of the vehicle on the surrounding area map which are to be inputted to a vehicle control mechanism of an automated-driving car.

2. The travel assist system according to claim 1, wherein the processing circuitry
calculates a position correction amount for correcting the positional information, based on the calculated vehicle position, and
corrects the positional information based on the position correction amount.

3. The travel assist system according to claim 1,
wherein the processing circuitry extracts a road shape, including a number of intersecting roads and an angle between the intersecting roads, as the road characteristic.

4. The travel assist system according to claim 1,
wherein the processing circuitry extracts a position of a feature and a shape of the feature, as the road characteristic.

5. The travel assist system according to claim 1, comprising
A memory to store a high-precision map used for automated driving and having a higher precision than the simple map,
wherein the processing circuitry aligns the high-precision map and the surrounding area map with each other and aligns the simple map and the surrounding area map with each other, thereby aligning the high-precision map and the simple map with each other, and calculates the vehicle position.

6. The travel assist system according to claim 1, comprising
a characteristic database to specify the road characteristic,
wherein the processing circuitry extracts the road characteristic from each of the surrounding area map and the simple map which includes the travel route, based on the road characteristic specified by the characteristic database.

7. The travel assist system according to claim 1,
wherein a road included in each of the surrounding area map and the simple map which includes the travel route is composed of a plurality of section Identifiers (IDs), and
wherein the processing circuitry extracts the road characteristic using each of the plurality of section IDs.

8. The travel assist system according to claim 1,
wherein the processing circuitry generates the surrounding area map by Simultaneous Localization And Mapping (SLAM).

9. The travel assist system according to claim 1,
wherein the simple map is a map used by a car navigation system.

10. The travel assist system according to claim 1,
wherein the processing circuitry acquires the positional information by Global Positioning System (GPS).

11. A travel assist method for a travel assist system which assists travel of a vehicle, the travel assist method comprising:
acquiring positional information of the vehicle;
generating a travel route indicating which road the vehicle takes on a simple map used for course guidance, utilizing the positional information and simple map information which represents the simple map;
generating, during travel of the vehicle, a surrounding area map of the vehicle as surrounding area map information, using the positional information and sensor information which is acquired by a sensor mounted in the vehicle, the surrounding area map having a higher precision than the simple map;
extracting a road characteristic on each of the surrounding area map and the simple map which includes the travel route;
aligning the simple map and the surrounding area map with each other based on the road characteristic, and calculating a position of the vehicle as a vehicle position; and
projecting the travel route generated with utilizing the simple map information and the positional information onto the surrounding area map using the vehicle position, and generating a path for the vehicle to take for traveling the travel route, based on the travel route projected onto the surrounding area map, the path being a travel track of the vehicle and a course of the vehicle on the surrounding area map which are to be inputted to a vehicle control mechanism of an automated-driving car.

12. A non-transitory computer readable medium storing a travel assist program which causes a computer to execute:
a positional information acquisition process of acquiring positional information of a vehicle;
a route generation process of generating a travel route indicating which road the vehicle takes on a simple map used for course guidance, utilizing the positional information and simple map information which represents the simple map;
a surrounding area map generation process of generating a surrounding area map of the vehicle, during travel of the vehicle, as surrounding area map information, using the positional information and sensor information which is acquired by a sensor mounted in the vehicle, the surrounding area map having a higher precision than the simple map;
a characteristic extraction process of extracting a road characteristic on each of the surrounding area map and the simple map which includes the travel route;
an alignment process of aligning the simple map and the surrounding area map with each other based on the road characteristic, and calculating a position of the vehicle as a vehicle position; and
a path generation process of projecting the travel route generated with utilizing the simple map information and the positional information onto the surrounding area map using the vehicle position, and generating a path for the vehicle to take for traveling the travel route, based on the travel route projected onto the surrounding area map, the path being a travel track of the vehicle and a course of the vehicle on the surrounding area map which are to be inputted to a vehicle control mechanism of an automated-driving car.
